(19) United States
(12) Patent Application Publication
(10) Pub. No.: US 2026/0220458 A1
(43) Pub. Date: Jul. 30, 2026

(54) METHODS, SYSTEMS, AND COMPUTER READABLE MEDIA FOR TRAINING GROWING NEURAL NETWORKS TO OUTPERFORM FIXED-SIZED NEURAL NETWORKS

(71) Applicant: North Carolina State University, Raleigh, NC (US)

(72) Inventors: William Lawrence Ditto, Wake Forest, NC (US); Anil Radhakrishnan, Raleigh, NC (US); John Florian Lindner, Cary, NC (US)

(21) Appl. No.: 19/458,726

(22) Filed: Jan. 24, 2026

Related U.S. Application Data
(60) Provisional application No. 63/749,508, filed on Jan. 25, 2025.

(51) Int. Cl. G06N 3/08; G06N 3/0499

(52) U.S. Cl. CPC G06N 3/08; G06N 3/0499

(57) ABSTRACT

A method for training a resizable, variable-sized, or growing feed-forward neural network, which can outperform comparable fixed-sized networks, includes initializing a feed-forward neural network with a number of current, effective, active, or activated neurons. The method further includes training the feed-forward neural network on multiple repetitions or epochs of training data, and, for each training epoch, evaluating a loss function having a value that depends on the number of current, effective, active, or activated neurons. The method further includes, after each training epoch, updating weights and biases of the feed-forward neural network and the number of current, effective, active, or activated neurons. The method further includes ceasing the training when the loss function reaches a desired value.

### PRIORITY CLAIM

This application claims the priority benefit of U.S. Provisional Patent Application Ser. No. 63/749,508 filed Jan. 25, 2025, the disclosure of which is incorporated herein by reference in its entirety.

### TECHNICAL FIELD

The subject matter described herein relates to training resizable, variable-sized, or growing neural networks. More particularly, the subject matter described herein relates to methods, systems, and computer readable media to improve neural network training by growing larger neural networks from smaller neural networks.

### BACKGROUND

Training artificial neural networks is a computationally intensive operation that typically involves providing the network with input data, generating output data using the network, quantifying the error between the output data and desired output data using a loss function, changing parameters of the network, and repeating the process until the error quantified by the loss function has been minimized to a desired level. Feed-forward neural networks involve multiplying input data by weights at each neuron in the network to generate the output. Each iteration in which input data passes through a feed-forward neural network to generate the output data is referred to as an epoch. After each training epoch, the weights of the neurons in the network are modified before next set of input data is input to the network. The larger the network and the greater the number of epochs required to find a minimum value of the loss function, the greater the computational cost and time of the training.

Conventionally, feed-forward neural networks remain fixed in size during training. That is, the number of neurons in the network is not changed during the training process. Training a feed-forward neural network with a fixed size can result in a failure to globally minimize the loss function and/or a large number of epochs to find a global minimum value of the loss function. In addition, the network may be unnecessarily large and complex, even if the value of the loss function is minimized during training.

In light of these and other difficulties, there exists a need for improved methods, systems, and computer readable media for training feed-forward neural networks.

### SUMMARY

A method for training a resizable, variable-sized, or growing feed-forward neural network includes initializing a feed-forward neural network with a number of current, effective, active, or activated neurons. The method further includes training the feed-forward neural network on multiple repetitions or epochs of training data, and, for each training epoch, evaluating a loss function having a value that depends on the number of current, effective, activated, or active neurons. The method further includes after each training epoch, updating weights and biases of the feed-forward neural network and the number of current, effective, active, or activated neurons. The method further includes ceasing the training when the loss function reaches a desired value.

According to another aspect of the subject matter described herein, initializing the feed-forward neural network with a number of effective, active, or activated neurons includes initializing the feed-forward neural network with a single neuron.

According to another aspect of the subject matter described herein, updating the number of current, effective, active or activated neurons includes increasing a number of the neurons participating in the training.

According to another aspect of the subject matter described herein, increasing the number of the neurons participating in the training includes adding neurons to the feed-forward neural network.

According to another aspect of the subject matter described herein, increasing the number of neurons participating in the training includes unmasking neurons present in the feed-forward neural network.

According to another aspect of the subject matter described herein, updating the number of current, effective, active, or activated neurons includes using a controller-mask algorithm that controls a number of neurons participating in the training.

According to another aspect of the subject matter described herein using the controller-mask algorithm includes computing a trainable control value, computing a neuron mask from the trainable control value, applying the neuron mask to the feed-forward neural network, computing a model prediction of the feed-forward neural network, computing, from the model prediction, a loss value that includes a size loss component, and updating the trainable control value.

According to another aspect of the subject matter described herein, updating the number of current, effective, active or activated neurons includes determining an optimal number of current, effective, active, or activated neurons using an auxiliary-weight algorithm.

According to another aspect of the subject matter described herein, determining the optimal number of current, effective, active, or activated neurons using neurons using the auxiliary-weight algorithm includes training the feed-forward neural network by evolving a size parameter N through evaluation of a size-dependent loss function.

According to another aspect of the subject matter described herein, the method includes selecting a learning rate for the feed-forward neural network to optimize the loss function for a given number of neurons and the trainable control value.

According to another aspect of the subject matter described herein, the method includes selecting a size-loss coupling parameter value to optimize the loss function for a given number of the training epochs.

According to another aspect of the subject matter described herein, a system for training a feed-forward neural network is provided. The system includes at least one processor and a memory. The system further includes a feed-forward neural network trainer implemented by the at least one processor for initializing a feed-forward neural network with a number of current, effective, active, or activated neurons, training the feed-forward neural network on multiple repetitions or epochs of training data, and, for each training epoch, evaluating a loss function having a value that depends on the number of current, effective, active, or activated neurons, after each training epoch, updating weights and biases of the feed-forward neural network and the number of current, effective, active, or activated neurons, and ceasing the training when the loss function reaches a desired value.

According to another aspect of the subject matter described herein, the feed-forward neural network trainer is configured to initialize the feed-forward neural network with a single neuron.

According to another aspect of the subject matter described herein, the feed-forward neural network trainer is configured to update the number of current, effective, active or activated neurons by increasing a number of the neurons participating in the training.

According to another aspect of the subject matter described herein, the feed forward neural network trainer is configured to increase the number of the neurons participating in the training by adding neurons to the feed-forward neural network.

According to another aspect of the subject matter described herein, the feed-forward neural network trainer is configured to increase the number of neurons participating in the training by unmasking non-participating neurons present in the feed-forward neural network.

According to another aspect of the subject matter described herein, the feed-forward neural network trainer is configured to update the number of current, effective, active, or activated neurons using a controller-mask algorithm that controls a number of neurons participating in the training.

According to another aspect of the subject matter described herein, the feed forward neural network trainer is configured to update the number of current, effective, active or activated neurons by determining an optimal number of current, effective, active, or activated neurons using an auxiliary-weight algorithm.

According to another aspect of the subject matter described herein, the feed forward neural network trainer is configured to determine the optimal number of current, effective, active, or activated neurons using neurons using the auxiliary-weight algorithm includes training the feed-forward neural network by evolving a size parameter N through evaluation of a size-dependent loss function.

According to another aspect of the subject matter described herein, the feed forward neural network trainer is configured to select a learning rate for the feed-forward neural network to optimize the loss function for a given number of neurons and the trainable control value.

According to another aspect of the subject matter described herein, the feed forward neural network trainer is configured to select a size-loss coupling parameter value to optimize the loss function for a given number of the training epochs.

According to another aspect of the subject matter described herein, a non-transitory computer readable medium having stored thereon executable instructions that when executed by a processor of a computer controls the computer to perform steps is provided. The steps include initializing a feed-forward neural network with a number of current, effective, active, or activated neurons. The steps further include training the feed-forward neural network on multiple repetitions or epochs of training data, and, for each training epoch, evaluating a loss function having a value that depends on the number of current, effective, active or activated neurons. The steps further include after each training epoch, updating weights and biases of the feed-forward neural network, including the number of current, effective, active, or activated neurons. The steps further include ceasing the training when the loss function reaches a desired value.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer-readable medium that implements the subject matter described herein may be located on a single device or computing platform or may be distributed across multiple devices or computing platforms.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Examples of the subject matter described herein will now be explained with reference to the accompanying drawings, of which:

FIG. 1 is a neural network diagram illustrating how a size-dependent loss function drives network size from 0 to 5 hidden neurons via gradient descent. Lines represent weights and circles represent biases, with thickness proportional to magnitude and color indicating sign (red for positive, blue for negative);

FIG. 2 includes graphs comparing training of a growing network (left column) versus a fixed-size network (right column). The top graphs show network size versus training epoch, the middle graphs show test loss versus epoch, and the bottom graphs show the target nonlinear relation and the final network approximation, with insets showing residuals;

FIG. 3 is a graph illustrating final test loss probability distributions after training rounds for growing and fixed networks learning a nonlinear relation with a minimum, averaged over multiple trials. Red lines indicate mean losses;

FIG. 4 is a graph illustrating final test loss probability distributions after training rounds for growing and fixed networks learning another nonlinear relation, averaged over multiple trials. Red lines indicate mean losses;

FIG. 5 is a graph illustrating final test loss probability distributions for growing and fixed networks performing a binary classification task, with an inset showing a representative confusion matrix;

FIG. 6 is a schematic diagram illustrating the controller-mask paradigm for up to N=4 hidden neurons. The mask M is mostly open with C₁=0.6, two hidden neurons ‘on’ (white squares), one partially ‘on’ (grey square), and one ‘off’ (black square). Lines represent weights and circles biases, thicknesses are proportional to magnitudes, red is positive and blue is negative, dashed lines suggest the effects of multiplicatively masking neuron outputs;

FIG. 7 includes graphs illustrating performance of the controller-mask algorithm on nonlinear regression and 2D classification tasks, showing mean test losses and standard deviation ranges;

FIG. 8 is a block diagram illustrating an exemplary system for training a feed-forward neural network, including a computing platform, processor, memory, and a neural network trainer;

FIG. 9 is a flow chart illustrating an exemplary process for training a feed-forward neural network, including steps for initialization, training, updating weights and neurons, and ceasing training when a desired loss value is reached;

FIG. 10 includes graphs illustrating dependence of auxiliary-weight algorithm for equation (3.13) simple Bessel function nonlinear regression. Final Loss L for growing networks across training duration E and size-loss coupling λ. Smaller losses L are better. The Dashed line in the density plot (left) is approximately E≈2000λ^{-0.8};

FIG. 11 includes graphs illustrating relative performance dependence of auxiliary-weight algorithm for equation (3.13) simple Bessel function nonlinear regression against static networks trained for same duration E. The ratio R≈L^{g}_{f}/L^{s}_{f} of the final losses of growing networks over that of static networks across training duration E and size-loss coupling λ is illustrated. Ratios R<1 demonstrate growing network superiority. The dashed line in density plot (left) is approximately E≈2000λ^{-0.8};

FIG. 12 includes graphs illustrating the scaling of controller-mask (equation 4.7) composite Bessel function regression versus number of training epochs E and hidden neurons N, for different learning rates η. The top row plots the difference δL between the mean final growing and static losses, where growing overperforms static in the blue regions. The bottom row plots the control value C₁ versus epoch. In between, when the growing network matures just at training's end, growing overperforms static. Dashed lines highlight the transition at C₁~0.7; and

FIG. 13 includes graphs illustrating the scaling of controller-mask spiral pattern classification. The three-dimensional plot shows that accuracy A increases with increasing neurons N and decreases with increasing number of classes N_{c} but with growing outperforming static always. The two-dimensional plots show cross sections and accuracy ratio. Growing is as accurate as static with just half the neurons.

### DETAILED DESCRIPTION

In contrast to conventional artificial neural networks, which are large and structurally static, consider resizable or variable-sized feed-forward neural networks that are small and dynamic, whose nodes can be added (or subtracted) during training. In one example, a single neuronal weight in the network controls the network's size, while the weight itself is optimized by the same gradient-descent algorithm that optimizes the network's other weights and biases, but with a size-dependent objective or loss function. In the examples described herein, we train and evaluate such “nimble neural networks” on nonlinear regression and classification tasks where they outperform the corresponding static networks, i.e., those in which the number of neurons is fixed during training. Growing networks to minimal, appropriate, or optimal sizes while training elucidates network dynamics and contrasts with pruning large networks after training but before deployment.

### Introduction

Artificial neural networks are increasingly important in society, technology, and science, including the mathematical, physical, and engineering sciences, and they are increasingly large and energy hungry. Indeed, the escalating carbon footprint of large-scale computing is a growing economic and societal burden [1]. Must we always use brute force, or can we get by with less?

Computation itself is widespread in both the natural and human-made worlds. Even single pendulums have machine-learning potential [2]. Networks of nonlinear systems are still more powerful, and physics-informed neural networks can even forecast the dynamics of systems that mix order and chaos [3]. Almost all real world networks are evolving networks, from the addition of contacts in a social network to route maps of airline traffic to disease spread [4]-[6]. However, learning networks that add or remove nodes are considerably less explored, leaving conventional neural networks centered around optimization of topologically static graphs, where the layer sizes are chosen arbitrarily via trial and error techniques [7,8]. These static networks, while computationally effective, do not offer any intuition for the minimal requirement to model a problem.

Toward dynamical networks, the neuro-evolution of augmenting topologies is a genetic algorithm that evolves the least complex network topology capable of approximating a target function [9]. Cascade correlation adds but does not remove nodes and does not use the powerful machine-learning tool of backpropagation [10]. In reservoir computing, evolved networks can be significantly smaller than their randomly connected counterparts [11]. Neural networks that learn their own activation functions diversify and outperform their homogeneous counterparts on image classification and nonlinear regression tasks [12]. Adaptive dynamical networks can change their connectivity over time depending on their state, and machine learning techniques have been used to study the dynamics of adaptive epidemiological networks [14]. Neural network pruning reduces unneeded neurons after training but before deployment [15]. Here, our goal is to start small and study the dynamics of feed-forward neural networks whose nodes can be dynamically added (and removed) during training based on an objective or loss function. A single neuronal weight in the network will control the network size, while the weight itself will be optimized by the same loss-function gradient-descent algorithm that optimizes the other weights and biases. Section 2 reviews the theory of artificial neural networks. Section 3 introduces our auxiliary-weight algorithm, a size-dependent-loss gradient-descent that naturally evolves the network size and demonstrates it on simple nonlinear regression and classification examples. Section 3 describes a related algorithm, using a separate controller and a mask, with similar results. Section 5 discusses future work.

### 2. Neural Networks

Feed-forward neural networks are interconnected nodes that are organized in layers, with an input layer, one or more hidden layers, and an output layer. The neurons possess an activation function σ that acts on the input and, sometimes, a bias that serves as an affine offset. These neurons are connected to each other with weights. This gives the networks the structure of a nested nonlinear function composed of linearly combined activities, which are summarized by

$$\hat{y} ( x ) = … {w}^{4} σ ( {w}^{3} σ ( {w}^{2} x + {b}^{2} ) + {b}^{3} ) + {b}^{4} , \qquad ( 2.1 )$$

where w^{l} and b^{l} are the weight matrices and bias vectors of layer l (which the input layer l=1 lacks). The weights and biases are free parameters that are tuned during the optimization process. Typical activation functions σ(z) look like tanh(z) or ReLU(z)=max(z,0).

For example, a neural network of 1 input, 1 output, and a single layer of 3 hidden neurons, outputs

$$\begin{matrix}\hat{y} ( x ) = + {w}_{11}^{3} σ ( {w}_{12}^{2} x + {b}_{1}^{2} ) \\ + {w}_{12}^{3} σ ( {w}_{22}^{2} x + {b}_{2}^{2} ) \\ + {w}_{13}^{3} σ ( {w}_{32}^{2} x + {b}_{3}^{2} ) + {b}_{1}^{3} ,\end{matrix} \qquad ( 2.2 )$$

where the weights and biases

$${w}_{n m}^{l} and {b}_{n}^{l}$$

are real numbers. If σ(x)=tanh(x), the special case

$$\hat{y} ( x ) = σ ( x - 6 ) - σ ( x - 8 ) \qquad ( 2.3 )$$

generates a blip of height 2 tanh(1) centred at x=7, and combining multiple such blips at different locations with different heights can approximate any reasonable function arbitrarily well, which implies the neural network universal approximation theorems [16,17].

An error or objective function, sometimes called a cost or loss function L, quantifies the performance of the network. Training attempts to minimize the loss function by repeatedly decrementing the network's weight and bias parameters p by the loss gradients

$$p ← p - η \frac{\partial L}{\partial p} , \qquad ( 2.4 )$$

where η is the learning rate. While such gradient descent is not guaranteed to find a global minimum, it often finds good local minima. The derivatives needed for this gradient based optimization are typically computed by backpropagation, which is a special case of reverse-mode automatic differentiation [18]. Guided by the differential calculus chain rule and iterating backward from the network's last layer, backpropagation recursively computes the gradients one layer at a time, avoiding redundant calculations.

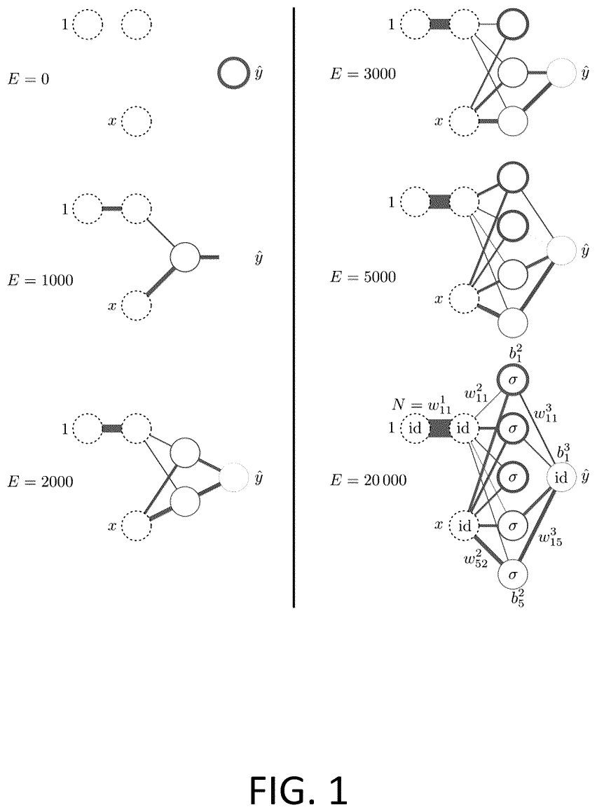

FIG. 1 is a neural network diagram illustrating how a loss function drives network size from 0 to 5 hidden neurons via gradient descent. At each training round or epoch E, lines represent weights and circles biases, partially labeled at bottom, thicknesses are proportional to magnitudes, red is positive and blue is negative. The prepended 1s are converted to the weight

$${w}_{11}^{1} = {a}_{1}^{1}$$

by an identity activation with zero bias, and

$$N = {w}_{11}^{1}$$

is the network size, which size-dependent-loss gradient descent naturally adjusts along with the other weights and biases.

### 3. Auxiliary-Weight Algorithm

### (a) Design

A size-dependent loss function itself can drive the network size via gradient descent if the size is identified with an auxiliary weight using the JMP algorithm [19-21], as illustrated by FIG. 1. An identity activation function with a zero bias converts the prepended 1s to the weight

$${w}_{11}^{1} = {a}_{1}^{1} like {a}_{1}^{1} = {σ}_{1}^{0} ( {w}_{11}^{1} {a}_{1}^{0} + {b}_{1}^{1} ) = i d ( {w}_{11}^{1} 1 + 0 ) = {w}_{11}^{1} , \qquad ( 3.1 )$$

where N=w₁¹ is identified with the network size, which gradient descent naturally adjusts along with the other weights and biases. When N increases by 1, a hidden neuron can be added (or activated), and when N decreases by 1, a hidden neuron can be deleted (or deactivated). Although the JMP algorithm has been previously used to learn eigenvalues as the network learns eigenfunctions, as far as we know, this is the first time it has been used to control a network's size.

Terms can be added to the objective or loss function L₀ to control size variability. For example, if

$$L = {L}_{0} + δ L , \qquad ( 3.2 )$$

then the C^{∞} valley

$$δ L = {λ}_{1} {e}^{- n + {n}_{1}} + {λ}_{2} {e}^{n - {n}_{2}} \qquad ( 3.3 )$$

can discourage the network from becoming too small or large, and the C¹ basin

$$δ L = \{ \begin{matrix}{{λ}_{1} ( {n}_{1} - N )}^{2} , & N \leq {n}_{1} , \\ 0 , & {n}_{1} < N < {n}_{2} , \\ {{λ}_{2} ( N - {n}_{2} )}^{2} , & {n}_{2} \leq N\end{matrix} \qquad ( 3.4 )$$

can confine the network size to [n₁, n₂].

### (b) Implementation

As an example, implementing such a network with a single hidden layer of up to 9 neurons as

$$\begin{matrix}\hat{y} ( x ) = + {w}_{11}^{3} {σ}_{0 - N} ( {Nw}_{11}^{2} + {w}_{12}^{2} x + {b}_{1}^{2} ) \\ + {w}_{12}^{3} {σ}_{1 - N} ( {Nw}_{21}^{2} + {w}_{22}^{2} x + {b}_{2}^{2} ) \\ + … \\ + {w}_{19}^{3} {σ}_{8 - N} ( {Nw}_{91}^{2} + {w}_{92}^{2} x + {b}_{9}^{2} ) + {b}_{1}^{3} ,\end{matrix} \qquad ( 3.5 )$$

where the potential activation functions

$${σ}_{r} ( x ) = {θ}_{r} σ ( x ) = {θ}_{r} tanh ( x ) , \qquad ( 3.6 )$$

and the C¹ step (down) function

$${θ}_{r} = \{ \begin{matrix}1 , & r < - 1 , \\ {sin}^{2} ( r π / 2 ) , & - 1 \leq r \leq 0 , \\ 0 , & 0 < r\end{matrix} \qquad ( 3.7 )$$

effectively adds and deletes neurons from the network. To avoid loss-function spikes, the smooth steps θᵣ gradually activate or deactivate neurons, so

$$ℝ ∋ {w}_{11}^{1} = N \approx {\sum }_{n = 0}^{8} θ ( n - N ) \qquad ( 3.8 )$$

is a good measure of the network size.

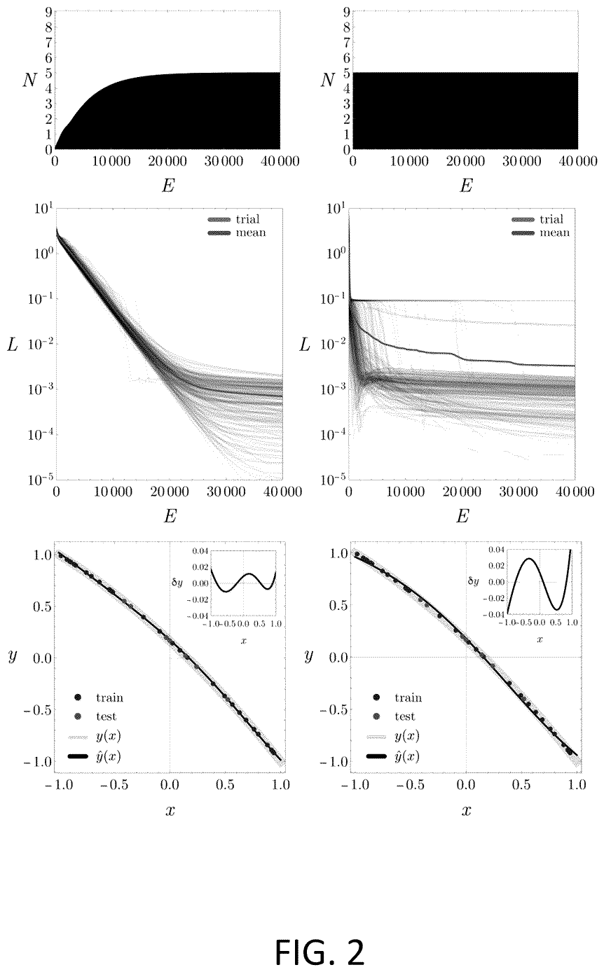

FIG. 2 illustrates graphs of training a growing network (left column) versus a known network (right column) via a loss function. The top row shows network size N versus training epoch E. The graphs in the middle row show test loss L versus epoch E for nᵢ=200 initial weights and biases. The growing network outperforms the grown network, with the mean final grown loss about 4.7 times the mean final growing loss. The graphs in the bottom row illustrate target nonlinear relation y(x) and representative final network approximation ŷ(x). Of the 40 data pairs, 80% are training pairs (blue dots) and 20% are testing pairs (red dots) not used to train the network. Insets are residuals δy=ŷ−y. Learning rate η=0.001, and size-loss coupling λ=0.1.

Start with N=0 hidden neurons, so

$$\hat{y} ( x ) = {b}_{1}^{3} ,$$

and choose a loss function

$$L = {L}_{0} + δ L , \qquad ( 3.9 )$$

where the base loss varies as the mean-square error

$${L}_{0} = \frac{1}{{n}_{t}} {\sum }_{n = 1}^{{n}_{t}} {( {y}_{n} - \hat{y} ( {x}_{n} ) )}^{2} = 〈 {( y - \hat{y} )}^{2} 〉 , \qquad ( 3.1 )$$

which vanishes for perfect agreement ŷ=ŷ, and the size loss

$$δ L = {λ ( N - {n}_{∞} )}^{2} , \qquad ( 3.11 )$$

encourages the network to grow to a final size of N=n_{∞} hidden neurons. Update the weights and biases, including

$$N = {w}_{11}^{1} ,$$

via the gradient descent

$${w}_{n m}^{l} ← {w}_{n m}^{l} - η \frac{\partial L}{\partial {w}_{n m}^{l}} , \qquad ( 3.12 a )$$

$${b}_{n}^{l} ← {b}_{n}^{l} - η \frac{\partial L}{\partial {b}_{n}^{l}} . \qquad ( 3.12 b )$$

As network size varies with training, the functional forms of the network ŷ(x), the loss L, and the gradients

$$\partial L / \partial {w}_{n m}^{l} , \partial L / \partial {b}_{n}^{l}$$

effectively change as terms come and go, complexifying for large sizes and simplifying for small sizes. In particular, the loss landscape changes, becoming higher dimensional as neurons are added and lower dimensional as neurons are subtracted.

### (c) Regression Examples

As a nonlinear target, use the Bessel function

$$y ( x ) = a + b {J}_{0} ( x ) \qquad ( 3.13 )$$

with y∈[−1,1] for x∈[−1,1], and choose nₜ=40 random data pairs {xₙ, y(xₙ)}, 80% for training and 20% for testing. Choose target network size n_{∞}=5, size loss influence λ=0.1, learning rate η=0.001, and descend for n_{E}=4×10⁴ epochs. A growing network outperforms a grown network averaged over nᵢ=200 initial weights and biases, as summarized by FIG. 2. One advantage of the growing network is fewer local minima when smaller and thus less chance of getting temporarily or permanently stuck in them on the descent to the global minimum, as is clear in this case, where the grown loss plummets initially but then often stalls at large losses.

For a concave example, compare the growing and grown networks learning the nonlinear relation

$$y ( x ) = \frac{( {x}^{2} - 5 x - 1 )}{5} \qquad ( 3.14 )$$

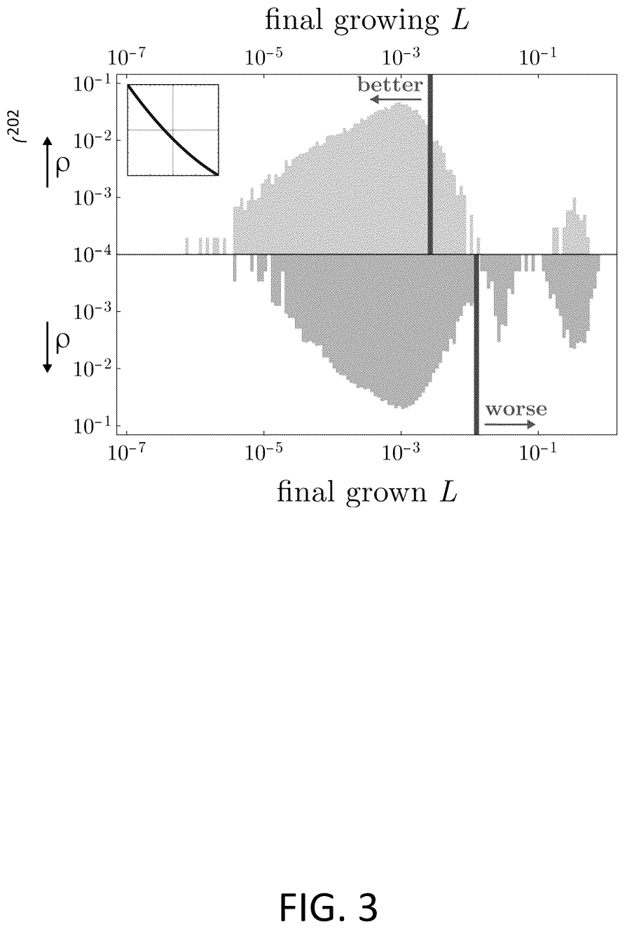

from 40 data pairs, 80% for training and 20% for testing, averaged over 10⁴ trials, each with different initial random weights and biases and with different data pairs, as summarized by FIG. 3. The orange and blue graphs are probability distributions of the mean final network test loss L after 4×10⁴ training rounds or epochs. To facilitate comparison, the orange histogram is upright and the blue histogram is inverted (as emphasized by the leftmost arrows). The orange histogram corresponds to the growing network, 0≤N≤5, while the blue histogram corresponds to the “grown” network, whose size is fixed at the final size of the growing networks, N=5. The histograms capture the final distributions of the network losses, while the red lines indicate the means (corresponding to the rightmost heights of the grey and red traces in the analogue of FIG. 2 loss plots), with the mean final grown loss about 4.7 times larger (and so worse) than the mean final growing loss. Once again, the growing network has fewer local minima to frustrate the gradient descent.
For an example with a minimum, compare the growing and grown networks learning the nonlinear relation

$$y ( x ) = \frac{( 3 {x}^{2} - 3 x - 2 )}{4} , \qquad ( 3.15 )$$

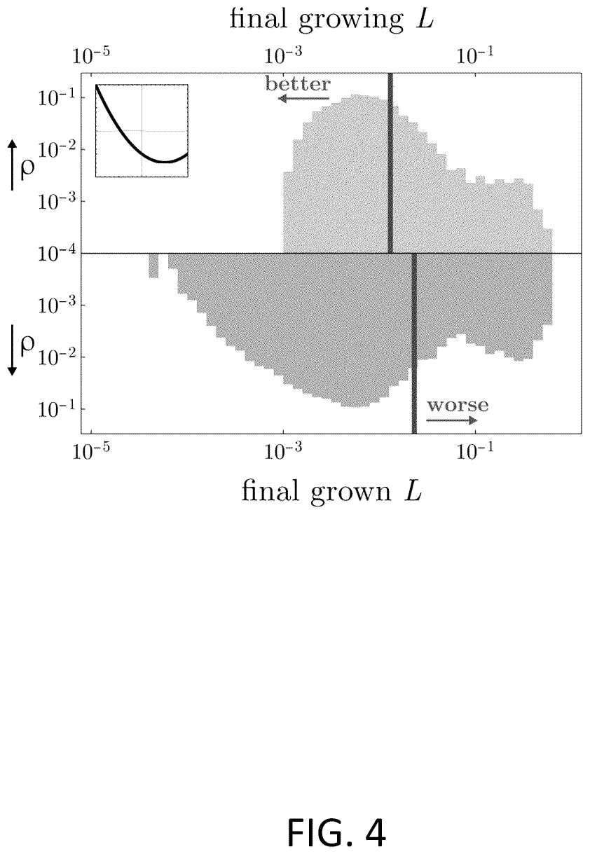

still from just 40 training pairs, averaged over 104 trials, as summarized by FIG. 4 final test loss L probability distributions, with the mean final grown loss about 1.8 times larger (and so worse) than the mean final growing loss.

FIG. 3 is a graph illustrating final test loss L probability distributions after 2×10⁴ training rounds for growing (top) and grown (bottom) networks learning a nonlinear relation with a minimum (inset), averaged over 10⁴ trials, each with different initial random weights and biases and with 40 different random data pairs, 80% training and 20% testing. Red lines indicate means, with the mean final grown loss about 1.8 times the mean final growing loss. Learning rate η=0.001, and size-loss coupling λ=0.1.

FIG. 4 is a graph illustrating final test loss L probability distributions after 2×10⁴ training rounds for growing (top) and grown (bottom) networks learning a nonlinear relation with a minimum (inset), averaged over 10⁴ trials, each with different initial random weights and biases and with 40 different random data pairs, 80% training and 20% testing. Red lines indicate means, with the mean final grown loss about 1.8 times the mean final growing loss. Learning rate η=0.001, and size-loss coupling λ=0.1.

### (d) Classification Example

For a binary classification example, replace the final identity activation function with the logistic sigmoid

$$s ( a ) = \frac{1}{1 + {e}^{- a}} \qquad ( 3.16 )$$

to output probabilities

$$[ 0 , 1 ] ∍ y ( x ) = s ( + {w}_{11}^{3} {σ}_{N - 0} ( {Nw}_{11}^{2} + {xw}_{12}^{2} + {b}_{1}^{2} ) + {w}_{12}^{3} {σ}_{N - 1} ( {Nw}_{21}^{2} + \qquad ( 3.17 )$$

$${xw}_{22}^{2} + {b}_{2}^{2} ) + … + {w}_{19}^{3} {σ}_{N - 8} ( {Nw}_{91}^{2} + {xw}_{92}^{2} + {b}_{9}^{2} ) + {b}_{1}^{3} ) .$$

Replace the base mean-square-error loss function with the binary cross-entropy

$$\begin{matrix}{L}_{0} = - \frac{1}{{n}_{t}} {\sum }_{n = 1}^{{n}_{t}} ( {y}_{n} log \hat{y} ( {x}_{n} ) + ( 1 - {y}_{n} ) log ( l - \hat{y} ( {x}_{n} ) ) ) \\ = - 〈 y log \hat{y} 〉 = 〈 y log \frac{1}{\hat{y}} 〉 \geq 0\end{matrix} , \qquad ( 3.18 )$$

which vanishes for perfect classification, ŷ=y=0 and ŷ=y=1.
Compare the growing and grown networks learning the classification {xₙ, yₙ} with

$${y}_{n} = ⌊ 1 + sin ( 2 π {x}_{n} ) ⌋ ∈ \{ 0 , 1 \}$$

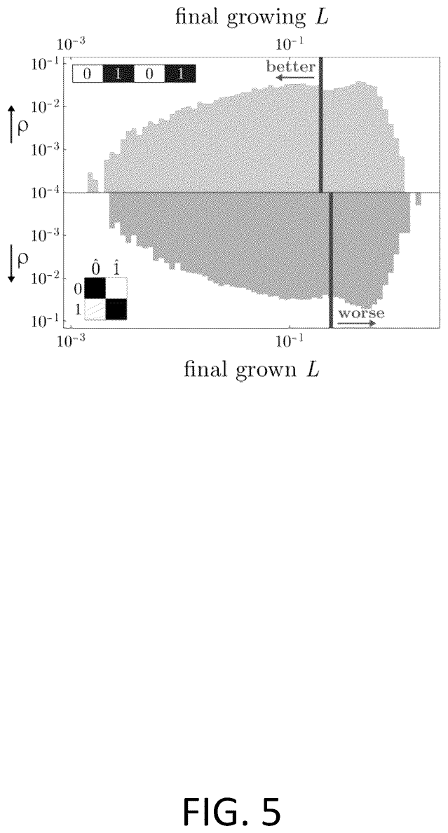

for xₙ∈[−1,1], from 40 training pairs averaged over 10⁴ trials, as summarised by the FIG. 5 final loss L probability distributions, with the mean final grown loss about 1.2 times larger (and so worse) than the mean growing loss.

FIG. 5 is a graph illustrating final test loss L probability distributions after 10⁴ training rounds for growing (top) and grown (bottom) networks classifying points on a line (top-left inset), averaged over 10⁴ trials, each with different initial random weights and biases and with 40 different random training pairs. Red lines indicate means, with the mean final grown loss about 1.2 times the mean final growing loss. Representative confusion matrix (bottom-left inset with grayscale running from white 0 to black 1) reflects 97% accuracy. Learning rate η=0.08, and size-loss coupling λ=0.01.

### 4. Controller-Mask Algorithm

Alternately, instead of augmenting the classic Multi-Layer Perceptron (MLP) with an auxiliary neuron and weight, we can separate the controller from the MLP. This allows us to use any controller of arbitrary complexity as long as it uses differentiably optimizable parameters. The auxiliary neuron implementation can be recovered by a single parameter controller with a dot product operation,

$$controller ( x ) = w \cdot x , \qquad ( 4.1 )$$

where w is a tunable parameter.
Given the controller, we can constrain network size by mapping the controller output value to a mask that can be applied to the vectorized layer-wise forward operation of the MLP with minimal overhead. Define

$${C}_{1} = controller ( 1 ) , \qquad ( 4.2 )$$

normalize and scale it to

$${N}_{norm} = N {sin}^{2} ( {C}_{1} π / 2 ) , \qquad ( 4.3 )$$

for use in a

$$filter = min ( max ( ⌊ {N}_{norm} ⌋ , 0 ) , N ) \qquad ( 4.4 )$$

to create a

$$M ( n ) = \{ \begin{matrix}1 , & n < filter , \\ \{ {N}_{norm} \} , & n = filter , \\ 0 , & n > filter ,\end{matrix} \qquad ( 4.5 )$$

where {x}=x−┌x┐ is the fractional part, 1 is “transparent”, 0 is “opaque”, and n∈{0, 1, 2, . . . , N−1} indexes the hidden layer neurons. For a quadratic size loss,

$${L}_{size} = {λ ( {C}_{1} - 1 )}^{2} , \qquad ( 4.6 )$$

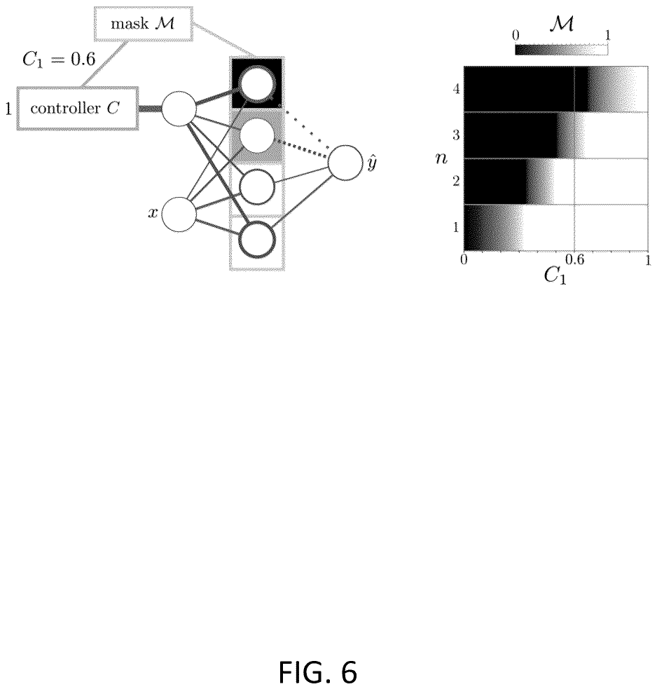

with a sufficiently large size-loss coupling 2, optimisation drives C₁→1 and hence Nₙₒᵣₘ→N, so the mask gradually opens wider allowing more hidden neurons to participate in the learning process, effectively growing the network. The complete algorithm using this controller-MLP scheme is visualized in FIG. 6, outlined in Algorithm 1, and implemented with the JAX [22,23] Python library using Equinox.

Using the controller-mask algorithm, we again find that the growing networks can outperform grown (and hence fixed) networks in nonlinear regression and classification tasks, as in FIG. 6, where networks fit the Bessel function:

$$f ( x ) = a + b ( {J}_{0} ( x ) + {J}_{1} ( x ) + {J}_{2} ( x ) ) \qquad ( 4.7 )$$

and classify points clustered in spirals.

FIG. 6 is a schematic diagram illustrating the controller-mask paradigm schematic for up to N=4 hidden neurons. The mask M is mostly open with C₁=0.6, two hidden neurons “on” (white squares), one partially “on” (grey square), and one “off” (black square). Lines represent weights and circles biases, thicknesses are proportional to magnitudes, red is positive and blue is negative, dashes suggest the effects of masking.

The following table illustrates Algorithm 1 referenced above.

| Algorithm | Controller-mask grows an MLP while solving a regression | |
|---|---|---|
| 1. | problem. | |
| Require: | Training data (Xₜᵣₐᵢₙ, Yₜᵣₐᵢₙ), Number of epochs E, | |
| | Learning rate n, Maximum neurons per hidden | |
| | layer N, Size-loss coupling λ | |
| Ensure: | Trained MLP model with dynamic neuron adjustment | |
| 1: | Initialize MP model with input size dᵢₙ, output size dₒᵤₜ, | |
| | and hidden layers [h₁, h₂ . . . , h_{L}] | |
| 2: | Initialize Controller C | |
| 3: | Initialize Optimizer [symbol] (C, M) | |
| 4: | for epoch = 1 to E do | |
| 5: | C₁ ← C(1) | Compute control value |
| 6: | X_{new} ← concatenate | Augment input with |
| | (Xₜᵣₐᵢₙ, C₁) | control value |
| 7: | For each layer l in M do | |
| 8: | M ← control_to_ | Compute neuron mask |
| | mask(C₁, N) | |
| 9: | X_{new} ← apply_ | Apply mask to |
| | mask(X_{new}, M) | layer output |
| 10: | Xnew ← σ(l(X_{new})) | Pass through layer with |
| | | activation |
| 11: | end for | |
| 12: | Y_{pred}←M (X_{new}) | Compute model prediction |
| 13: | L_{base}← mean((Y_{pred} − Yₜᵣₐᵢₙ)²) | Compute base loss |
| 14: | L_{size}← mean((C₁ − 1)²) | Compute size loss |
| 15: | L← L_{base} + λL_{size} | Total loss |
| 16: | [symbol] ← pdate_optimizer( [symbol] , L) | |
| 17: | C← update_ | Update controller |
| | controller(C, [symbol] , L) | parameters |
| 18: | M← update_model(M, [symbol] , L) | Update model parameters |
| 19: | end for | |

| | |
|---|---|
| 20: | return Trained MLP model M and Controller C |

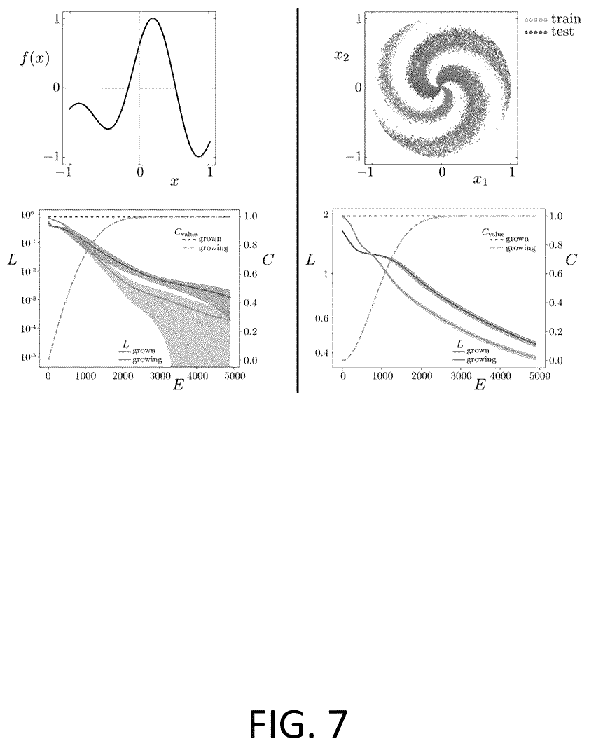

FIG. 7 includes graphs illustrating the controller-mask algorithm nonlinear regression example (left) and 2D classification example (right) for 2¹⁵ training pairs. Dark lines indicate mean test losses averaged over 100 trials and enclosing areas are plus or minus one standard deviation. In both cases, the growing network outperforms the grown network. Learning rate η=0.001, and size-loss coupling λ=0.32.

### 5. Discussion

Growing networks can dynamically evolve their size during gradient descent to help solve problems involving nonlinear regression and classification. Thanks to a novel use of auxiliary network weight, or a separate controller, network evolution can be tailored by modifying the loss function to bound the network final size or to select a desired asymptotic size.

Future work includes understanding how the size-dependent-loss gradient-descent algorithms scale with network size and task complexity, including higher-dimensional classification and regression problems. For small networks with size controllers, growing networks can outperform fixed networks of the same final size, but how do we best compare networks with and without the controllers, which themselves contribute to the overall networks' adjustable weights and biases? How small can the controllers be? How does controlling network size via the loss function compare with scheduling network size changes according to training epoch? Does the growing advantage depend on the training length or the learning rate? Is the advantage sensitive to the type of optimization (batch versus stochastic gradient descent, fixed versus variable descent rates)?

Rather than associate the network size with a single weight, one can associate unnormalized probabilities for increasing, decreasing, or unchanging the network size with multiple weights (or biases) and optimize them with gradient descent. These continuous variables can be normalized by dividing by their sum and then used in three-way decisions to direct the network size.

Diversity can be incorporated into this framework by varying the neuron activation functions [12], where the replacement of a neuron type is like a mutation, with the expectation that if one allows diversity in the growth strategy, the neural network evolution may converge to a smaller network; that is, reasonable performance may be obtained even with a small neural network if mutations are allowed. Combining growing and mutating neural networks with physics-informed neural networks may facilitate the forecasting of dynamical systems, both in toy models and in proof-of-concept applications.

For an ideal, infinitely-fast, infinitely-large computer, which could instantly optimize an artificial neural network's weights and biases, bigger is better. But for realistic finite computers, where optimization algorithms like gradient descent can be slow and frustrating, with no guarantee of successfully reaching a global minimum, growing networks can outperform fixed networks of the same final size, in part because when smaller the growing networks have fewer local minima to frustrate the gradient descent. Furthermore, “bigger is better” is problematic for practical computers because of their increasingly disproportionate economic, environmental, and societal footprints [25]. Much work remains, but we are intrigued by the possibilities of starting small.

### Exemplary System and Method

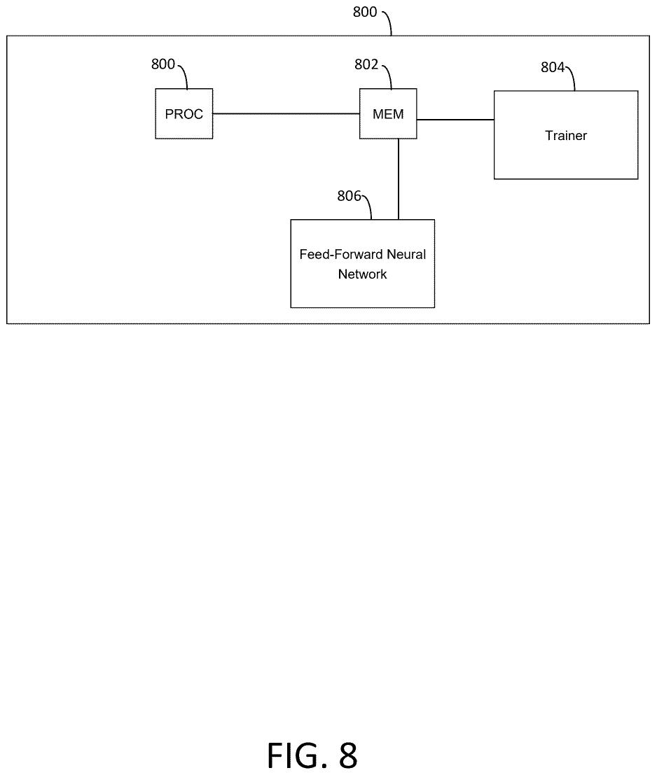

FIG. 8 is a block diagram illustrating an exemplary system for training a feed-forward neural network. Referring to FIG. 8, the exemplary system includes a computing platform 800 including at least one processor 802 and memory 804. The system further includes a feed-forward neural network trainer 806 that performs the processes described herein to train a feed-forward neural network 808 while changing the size of the network during the training. Feed-forward neural network trainer 806 and feed-forward neural network 808 may each be implemented using computer executable instructions stored in memory 804 and executed by processor 802.

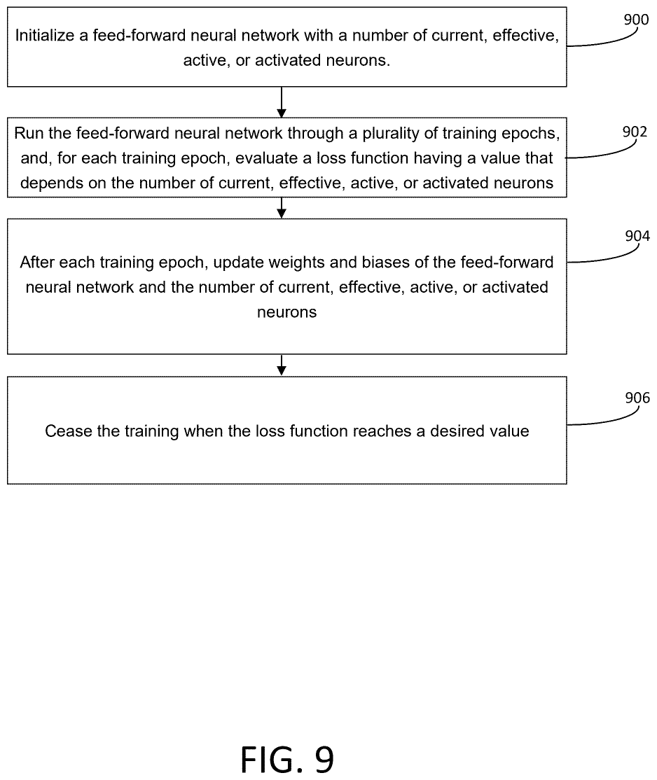

FIG. 9 is a flow chart illustrating an exemplary process for training a feed-forward neural network. Referring to FIG. 9, in step 900 the process includes initializing a feed-forward neural network with a number of current, effective, active, or activated neurons. For example, the network may start with a minimum number of activated neurons, such as a single neuron.

In step 904, the process further includes training the feed-forward neural network on multiple repetitions or epochs of training data, and, for each training epoch, evaluating a loss function having a value that depends on the number of current, effective, active, or activated neurons. In one example, the feed-forward may be trained in each epoch to perform a linear regression task, a classification task, or other task. The number of current effective, active, or activated neurons include the neurons that are participating in the network during the training epoch. A neuron may be excluded from participating in a training epoch if the neuron is either not present in the network or is present but masked.

In step 906, the process further includes, after each training epoch, updating weights and biases of the feed-forward neural network and the number of current, effective, active, or activated neurons. In one example, an activated neuron is added to the network after each training epoch. In another example, a controller controls a mask parameter to increase the number of activated neurons that can participate in the training.

In step 908, the process further includes ceasing the training when the loss function reaches a desired value. For example, when the value of the loss function reaches a global minimum, the training may cease.

### Additional Experimental Results

### Growth-Training Dependence

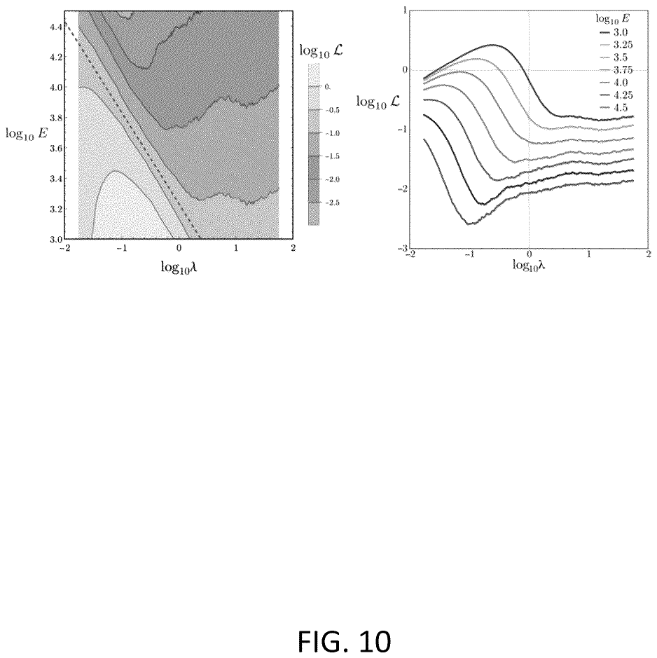

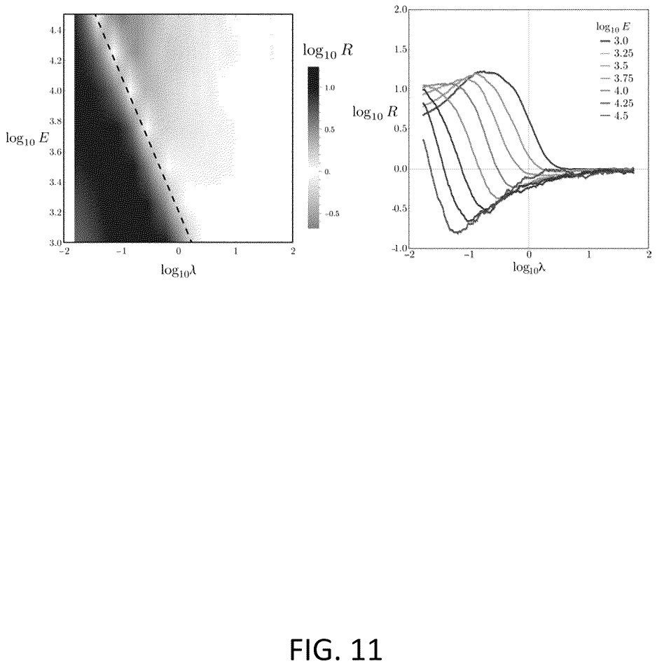

FIGS. 10 and 11 show how the auxiliary-weight algorithm's performance depends on the training duration E and size-loss coupling λ. We track the final loss L for the growing networks and also the ratio

$$R = {L}_{f}^{g} / {L}_{f}^{s}$$

of the final losses of growing networks over that of static networks. Lower values of L indicate better performance, and ratios R<1 demonstrate growing network superiority. We get similar results for both batch gradient descent (where weights and biases are updated after each epoch) and stochastic gradient descent (where weights and biases are updated after each training pair).

For large size-loss coupling λ, the growing network quickly grows to the same size as the static network, their final losses are similar, and the ratio R≈1. For small size-loss coupling λ, the growing network grows slowly and is still small at training's end, so its final losses are larger, and R≥1. Growing networks strategy is best for slow growth during long training. Linear features in density plots exhibit power-law scaling, with dashed lines approximately E≈2000λ^{-0.8}.

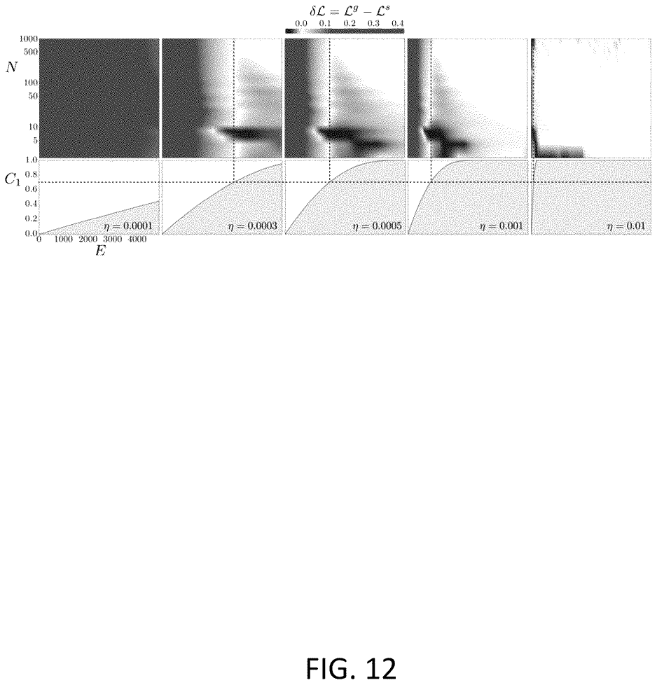

FIG. 12 reveals how the controller-mask algorithm's performance on equation 4.7 composite Bessel function regression varies with learning rate η, training epochs E and number of hidden neurons N. The top row displays the difference δ between the mean final losses of growing and static networks, with blue regions indicating where growing networks outperform static ones. The bottom row tracks the value from the controller C₁ over the training epochs.

When using adaptive optimizers, the learning rate η emerges as a critical factor in the growth dynamics. With small learning rates, C₁ increases slowly, keeping the network small throughout the training period. Large learning rates on the other hand cause rapid growth, quickly matching the static network's size and hence yielding a similar performance. The optimal regime occurs in the intermediate range, where growing networks reach full size towards the end of the training and outperform static networks. The transition threshold appears consistently at approximately C₁≈0.7 for this problem, as highlighted by the dashed lines.

This learning rate dependence, just as the size-loss coupling dependence before, demonstrates that the timing of the network growth relative to the training process is a crucial factor for performance optimization.

### Network Size Relations

To demonstrate the fundamental relationships between network size, network performance and task complexity, we systematically vary the number of hidden neurons N and the number of classification classes (spirals) N_{c} to find a surprising relationship between the accuracy of growing to static networks in the spiral classification problem.

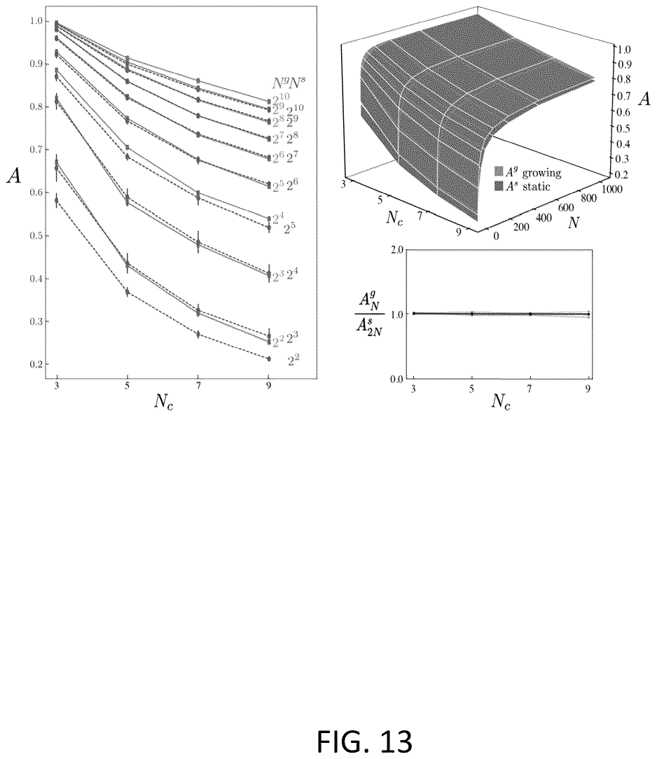

FIG. 13 demonstrates the relationship between network size and performance in growing and static networks across spiral classification task complexity. Three-dimensional visualization reveals that the classification accuracy A increases systematically with neuron count N while decreasing with the number of classes N_{c}. Two-dimensional cross-sectional and ratio plots establish a remarkable efficiency advantage: Growing networks achieve comparable accuracy to static networks while using only half the neurons, following the relationship

$${A}_{N}^{g} \approx {A}_{2 N}^{S}$$

for this classification task.

In summary, FIGS. 10-12 demonstrate how the growing advantage R scales with number of training epochs E, size-loss coupling λ, number of hidden neurons N, and learning rate η. FIG. 13 demonstrates how the classification accuracy A scales with number of classification classes N_{c} and number of hidden neurons N. These scaling results further elucidate growing neural networks and may help software and hardware engineers practically and competitively implement growing neural networks.

The disclosure of each of the following references is hereby incorporated by reference herein in its entirety.

### REFERENCES

1. Allen M. 2022 The huge carbon footprint of large-scale computing. Physics World 35, 46. (10.1088/2058-7058/35/03/32)
2. Mandal S, Sinha S, Shrimali M D. 2022 Machine-learning potential of a single pendulum. Phys. Rev. E 105, 054203. (10.1103/PhysRevE.105.054203)
3. Choudhary A, Lindner J F, Holliday E G, Miller S T, Sinha S, Ditto W L. 2020 Physics-enhanced neural networks learn order and chaos. Phys. Rev. E 101, 062207. (10.1103/PhysRevE.101.062207)
4. Zhou B, Holme P, Gong Z, Zhan C, Huang Y, Lu X, Meng X. 2023 The nature and nurture of network evolution. Nature Communications 14, 7031. (10.1038/s41467-023-42856-5)
5. Aggarwal C, Subbian K. 2014 Evolutionary Network Analysis: A Survey. ACM Comput. Surv. 47, 10:1-10:36. (10.1145/2601412)
6. Azizi A, Montalvo C, Espinoza B, Kang Y, Castillo-Chavez C. 2020 Epidemics on networks: Reducing disease transmission using health emergency declarations and peer communication. Infectious Disease Modelling 5, 12-22. (10.1016/j.idm.2019.11.002)
7. Berngardt O I. 2024 Minimum number of neurons in fully connected layers of a given neural network (the first approximation). arXiv:2405.14147 [cs] (10.48550/arXiv.2405.14147)
8. Hsu D, Sanford C H, Servedio R, Vlatakis-Gkaragkounis E V. 2021 On the Approximation Power of Two-Layer Networks of Random ReLUs. In Proceedings of Thirty Fourth Conference on Learning Theory pp. 2423-2461. PMLR.
9. Stanley K O, Miikkulainen R. 2002 Evolving Neural Networks through Augmenting Topologies. Evolutionary Computation 10, 99-127. (10.1162/106365602320169811)
10. Fahlman S, Lebiere C. 1997 The Cascade-Correlation Learning Architecture. Advances in Neural Information Processing Systems 2.
11. Yadav M, Sinha S, Stender M. 2024 Evolution beats random chance: Performance-dependent network evolution for enhanced computational capacity. arxiv:2403.15869.
12. Choudhary A, Radhakrishnan A, Lindner J F, Sinha S, Ditto W L. 2023 Neuronal diversity can improve machine learning for physics and beyond. Scientific Reports 13, 13962. (10.1038/s41598-023-40766-6)
13. Berner R, Gross T, Kuehn C, Kurths J, Yanchuk S. 2023 Adaptive dynamical networks. Physics Reports 1031, 1-59. (https://doi.org/10.1016/j.physrep.2023.08.001)
14. Evangelou N, Cui T, Bello-Rivas J M, Makeev A, Kevrekidis I G. 2024 Tipping points of evolving epidemiological networks: Machine learning-assisted, data-driven effective modeling. Chaos: An Interdisciplinary Journal of Nonlinear Science 34, 063128. (10.1063/5.0187511)
15. Blalock D, Ortiz J J G, Frankle J, Guttag J. 2020 What is the State of Neural Network Pruning?. arXiv:2003.03033.
16. Cybenko G. 1989 Approximation by superpositions of a sigmoidal function. Mathematics of Control, Signals, and Systems (MCSS) 2, 303-314. (10.1007/BF02551274)
17. Hornik K. 1991 Approximation capabilities of multilayer feedforward networks. Neural Networks 4, 251-257. (https://doi.org/10.1016/0893-6080 (91) 90009-T)
18. Linnainmaa S. 1976 Taylor expansion of the accumulated rounding error. BIT Numerical Mathematics 16, 146-160. (10.1007/BF01931367)
19. Jin H, Mattheakis M, Protopapas P. 2020 Unsupervised Neural Networks for Quantum Eigenvalue Problems. In 2020 NeurIPS Workshop on Machine Learning and the Physical Sciences. NeurIPS NeurIPS.
20. Jin H, Mattheakis M, Protopapas P. 2022 Physics-Informed Neural Networks for Quantum Eigenvalue Problems. In IJCNN at IEEE World Congress on Computational Intelligence.
21. Holliday E G, Lindner J F, Ditto W L. 2023 Solving quantum billiard eigenvalue problems with physics-informed machine learning. AIP Advances 13, 085013. (10.1063/5.0161067)
22. Bradbury J, Frostig R, Hawkins P, Johnson M J, Leary C, Maclaurin D, Necula G, Paszke A, VanderPlas J, Wanderman-Milne S, Zhang Q. 2018 JAX: composable transformations of Python+NumPy programs.
23. DeepMind, Babuschkin I, Baumli K, Bell A, Bhupatiraju S, Bruce J, Buchlovsky P, Budden D, Cai T, Clark A, Danihelka I, Dedieu A, Fantacci C, Godwin J, Jones C, Hemsley R, Hennigan T, Hessel M, Hou S, Kapturowski S, Keck T, Kemaev I, King M, Kunesch M, Martens L, Merzic H, Mikulik V, Norman T, Papamakarios G, Quan J, Ring R, Ruiz F, Sanchez A, Sartran L, Schneider R, Sezener E, Spencer S, Srinivasan S, Stanojevic' M, Stokowiec W, Wang L, Zhou G, Viola F. 2020 The DeepMind JAX Ecosystem.
24. Kidger P, Garcia C. 2021 Equinox: neural networks in JAX via callable PyTrees and filtered transformations. Differentiable Programming workshop at Neural Information Processing Systems 2021.
25. Varoquaux G, Luccioni A S, Whittaker M. 2024 Hype, Sustainability, and the Price of the Bigger-is-Better Paradigm in AI. arXiv:2409.14160.
26. Radhakrishnan, J. F. Lindner, S. T. Miller, S. Sinha, W. L. Ditto, Growing Neural Networks: Dynamic Evolution through Gradient Descent, Proceedings of the Royal Society A, volume 481, issue 2318, pages 20250222(1-15) (16 Jul. 2025)<http://doi.org/10.1098/rspa.2025.0222>

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for training a resizable, variable-sized, or growing feed-forward neural network, the method comprising:
initializing a feed-forward neural network with a number of current, effective, active, or activated neurons;
training the feed-forward neural network on multiple repetitions or epochs of training data, and, for each training epoch, evaluating a loss function having a value that depends on the number of current, effective, activated, or active neurons;
after each training epoch, updating weights and biases of the feed-forward neural network and the number of current, effective, active, or activated neurons; and
ceasing the training when the loss function reaches a desired value.

2. The method of claim 1 wherein initializing the feed-forward neural network with a number of effective, active, or activated neurons includes initializing the feed-forward neural network with a single neuron.

3. The method of claim 1 wherein updating the number of current, effective, active or activated neurons includes increasing a number of the neurons participating in the training.

4. The method of claim 3 wherein increasing the number of the neurons participating in the training includes adding neurons to the feed-forward neural network.

5. The method of claim 3 wherein increasing the number of neurons participating in the training includes unmasking neurons present in the feed-forward neural network.

6. The method of claim 1 wherein updating the number of current, effective, active, or activated neurons includes using a controller-mask algorithm that controls a number of neurons participating in the training.

7. The method of claim 6 wherein using the controller-mask algorithm includes:
computing a trainable control value;
computing a neuron mask from the trainable control value;
applying the neuron mask to the feed-forward neural network;
computing a model prediction of the feed-forward neural network; and
computing, from the model prediction, a loss value that includes a size loss component, and updating the trainable control value.

8. The method of claim 1 wherein updating the number of current, effective, active or activated neurons includes determining an optimal number of current, effective, active, or activated neurons using an auxiliary-weight algorithm.

9. The method of claim 8 wherein determining the optimal number of current, effective, active, or activated neurons using neurons using the auxiliary-weight algorithm includes training the feed-forward neural network by evolving a size parameter N through evaluation of a size-dependent loss function.

10. The method of claim 7 comprising selecting a learning rate for the feed-forward neural network to optimize the loss function for a given number of neurons and the trainable control value.

11. The method of claim 1 comprising selecting a size-loss coupling parameter value to optimize the loss function for a given number of the training epochs.

12. A system for training a feed-forward neural network, the system comprising:
at least one processor and a memory; and
a feed-forward neural network trainer implemented by the at least one processor for initializing a feed-forward neural network with a number of current, effective, active, or activated neurons, training the feed-forward neural network on multiple repetitions or epochs of training data, and, for each training epoch, evaluating a loss function having a value that depends on the number of current, effective, active, or activated neurons, after each training epoch, updating weights and biases of the feed-forward neural network and the number of current, effective, active, or activated neurons, and ceasing the training when the loss function reaches a desired value.

13. The system of claim 12 wherein the feed-forward neural network trainer is configured to initialize the feed-forward neural network with a single neuron.

14. The system of claim 12 wherein the feed-forward neural network trainer is configured to update the number of current, effective, active or activated neurons by increasing a number of the neurons participating in the training.

15. The system of claim 14 wherein the feed-forward neural network trainer is configured to increase the number of the neurons participating in the training by adding neurons to the feed-forward neural network.

16. The system of claim 14 wherein the feed-forward neural network trainer is configured to increase the number of neurons participating in the training by unmasking non-participating neurons present in the feed-forward neural network.

17. The system of claim 12 wherein the feed-forward neural network trainer is configured to update the number of current, effective, active, or activated neurons using a controller-mask algorithm that controls a number of neurons participating in the training.

18. The system of claim 17 wherein using the controller-mask algorithm includes:
computing a trainable control value;
computing a neuron mask from the trainable control value;
applying the neuron mask to the feed-forward neural network;
computing a model prediction of the feed-forward neural network; and
computing, from the model prediction, a loss value that includes a size loss component, and updating the trainable control value.

19. The system of claim 12 wherein the feed forward neural network trainer is configured to update the number of current, effective, active or activated neurons by determining an optimal number of current, effective, active, or activated neurons using an auxiliary-weight algorithm.

20. The system of claim 19 wherein the feed forward neural network trainer is configured to determine the optimal number of current, effective, active, or activated neurons using neurons using the auxiliary-weight algorithm includes training the feed-forward neural network by evolving a size parameter N through evaluation of a size-dependent loss function.

21. The system of claim 18 wherein the feed forward neural network trainer is configured to select a learning rate for the feed-forward neural network to optimize the loss function for a given number of neurons and the trainable control value.

22. The system of claim 12 wherein the feed forward neural network trainer is configured to select a size-loss coupling parameter value to optimize the loss function for a given number of the training epochs.

23. A non-transitory computer readable medium having stored thereon executable instructions that when executed by a processor of a computer controls the computer to perform steps comprising:
initializing a feed-forward neural network with a number of current, effective, active, or activated neurons;
training the feed-forward neural network on multiple repetitions or epochs of training data, and, for each training epoch, evaluating a loss function having a value that depends on the number of current, effective, active or activated neurons;
after each training epoch, updating weights and biases of the feed-forward neural network, including the number of current, effective, active, or activated neurons; and
ceasing the training when the loss function reaches a desired value.
